(19) United States
(12) Patent Application Publication
(10) Pub. No.: US 2017/0236171 A1
(43) Pub. Date: Aug. 17, 2017

(54) RELATIVE PRICING INDICATION ESTIMATION OF CONTENT ITEM CRITERIA

(71) Applicant: Google Inc., Mountain View, CA (US)

(72) Inventor: Yifang Liu, Redwood City, CA (US)

(21) Appl. No.: 14/449,020

(22) Filed: Jul. 31, 2014

(51) Int. Cl. G06Q 30/02

(52) U.S. Cl. CPC G06Q 30/0283; G06Q 30/0275

(57) ABSTRACT

Systems and methods for determining a relative pricing indication of content item criteria are provided. One method includes retrieving content item data relating to a plurality of content items. For each content item, a target pricing parameter and one or more selection criteria associated with the content item is determined, and the content item is categorized within one or more categories. For each of the categories, category pricing parameter data is generated based on a combination of the target pricing parameters for the content items within the category. For each of the selection criteria, a criteria pricing parameter is determined based on a combination of target pricing parameters for the content items with which the criterion is associated. Criteria pricing parameter data is correlated to the category pricing parameters for the one or more categories. Relative pricing indication data is generated for the criterion based on the correlation.

### BACKGROUND

Content providers often publish content items in networked resources through online content management systems with the goal of having an end user interact with (e.g., click through) the content items and perform a converting action, such as providing information of value to the content providers and/or purchasing a product or service offered by the content providers.

Different content items may be associated with different ranges of price levels of the products/services/brands/etc. the content items are designed to promote.

### SUMMARY

One illustrative implementation of the disclosure relates to a method for determining a relative pricing indication estimation of content item criteria. The method includes retrieving, by one or more processors, content item data relating to a plurality of content items configured for presentation to users via one or more online resources. The method further includes, for each of the plurality of content items, determining from the content item data, by the one or more processors, a target pricing parameter associated with the content item and one or more selection criteria associated with the content item used in determining whether to serve the content item to the users. For each of the plurality of content items, the content item is categorized within one or more categories based on the selection criteria. The method further includes, for each of the categories, generating, by the one or more processors, category pricing parameter data based on a combination of the target pricing parameters for the content items within the category. The category pricing parameter data for each category provides an indication of a level for the target pricing parameters of the content items within the category. The method further includes, for each of the criteria, determining, by the one or more processors, criteria pricing parameter data based on a combination of the target pricing parameters for the content items with which the criterion is associated. The criteria pricing parameter data for each criterion provides an indication of a level for the target pricing parameters of the content items associated with the criterion. For each of the criteria, the criteria pricing parameter data is correlated to the category pricing parameters for the one or more categories. For each of the criteria, relative pricing indication data for the criterion is generated based on the correlation of the criteria pricing parameter data to the category pricing parameter data for the one or more categories. The relative pricing indication data for each criterion provides an indication of a relative price level associated with the criterion in relation to the other criteria represented within the one or more categories.

Another implementation relates to a system. The system includes at least one computing device operably coupled to at least one memory. The system is configured to retrieve content item data relating to a plurality of content items configured for presentation to users via one or more online resources. The system is further configured to, for each of the plurality of content items, determine from the content item data a target pricing parameter associated with the content item, determine from the content item data one or more selection criteria associated with the content item used in determining whether to serve the content item to the user, and categorize the content item within one or more categories based on the selection criteria. The system is further configured to, for each of the categories, generate category pricing parameter data based on a combination of the target pricing parameters for the content items within the category. The category pricing parameter data for each category provides an indication of a level for the target pricing parameters of the content items within the category. The system is further configured to, for each of the selection criteria, calculate criteria pricing parameter data based on a combination of the target pricing parameters for the content items with which the criterion is associated, the criteria pricing parameter data for each criterion providing an indication of a level for the target pricing parameters of the content items associated with the criterion. The system is further configured to, for each of the selection criteria, correlate the criteria pricing parameter data to the category pricing parameter data for the one or more categories, and generate relative pricing indication data for the criterion based on the correlation of the criteria pricing parameter data to the category pricing parameter data for the one or more categories. The relative pricing indication data for each criterion provides an indication of a relative price level associated with the criterion in relation to the other criteria represented within the one or more categories.

Yet another implementation relates to one or more computer-readable storage media having instructions stored thereon that, when executed by one or more processors, cause the one or more processors to execute operations. The operations include retrieving content item data relating to a plurality of content items configured for presentation to users via one or more online resources. The operations further include for each of the plurality of content items, determining from the content item data a target pricing parameter associated with the content item, determining from the content item data one or more selection criteria associated with the content item used in determining whether to serve the content item to the users, and categorizing the content item within one or more categories based on the selection criteria. The operations further include, for each of the categories, generating category pricing parameter data based on a combination of the target pricing parameters for the content items within the category. The category pricing parameter data for each category provides an indication of a level for the target pricing parameters of the content items within the category. The operations further include, for each of the selection criteria, calculating criteria pricing parameter data based on a combination of the target pricing parameters for the content items with which the criterion is associated, the criteria pricing parameter data for each criterion providing an indication of a level for the target pricing parameters of the content items associated with the criterion. The operations further include, for each of the selection criteria, correlating the criteria pricing parameter data to the category pricing parameter data for the one or more categories, and generating relative pricing indication data for the criterion based on the correlation of the criteria pricing parameter data to the category pricing parameter data for the one or more categories. The relative pricing indication data for each criterion provides an indication of a relative price level associated with the criterion in relation to the other criteria represented within the one or more categories.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an analysis system and associated environment according to an illustrative implementation.

FIG. 2 is a flow diagram of a process for estimating relative pricing indications of content items according to an illustrative implementation.

FIG. 3 is a flow diagram of a process for determining a threshold pricing parameter for the category pricing parameter data according to an illustrative implementation.

FIG. 4 is a block diagram of a detailed implementation of an analysis system according to an illustrative implementation.

FIG. 5 is an illustration of a user interface configured to provide information pertaining to relative pricing indication data for a set of criteria for content items according to an illustrative implementation.

FIG. 6 is a block diagram of a computing system according to an illustrative implementation.

### DETAILED DESCRIPTION

Referring generally to the Figures, various illustrative systems and methods are provided that may be used to estimate a relative pricing indication of content item criteria, such as keywords associated with a content item. The relative pricing indication for a criterion of a content item is based on a comparison between the criteria pricing parameters and category pricing parameters for categories associated with the criteria. In other words, a relative pricing indication may be estimated for a criterion based on pricing parameters for the criterion (e.g., such as CPA and CPD) and one or more categories to which the criterion belongs.

The relative pricing indication may be used for a variety of purposes. For instance, each content item may be assigned a pricing indication based on the pricing indications of the criteria associated with the content item. In some implementations, the relative pricing indications may be used to determine whether or not to present a particular content item to a user. In some implementations, the relative pricing indications may be used to determine or adjust a bid value for presenting the content item to a user. The relative pricing indication may be used to help properly value a product, service or brand associated with a content item. For instance, the relative pricing indication may be used to determine if a product, service or brand associated with a content item has a higher or lower price than the typical content item for a similar product, service or brand.

Different content items may be associated with different relative pricing indications (e.g., metrics related to the cost/price levels of the produces, services, or brands the content items are designed to promote.) The systems and methods of the present disclosure may be used to determine relative pricing indications (or other price value characteristics) associated with different content item criteria (e.g., keywords). In some embodiments, the relative pricing indications may provide an indication of the relative pricing associated with particular criteria in relation to other criteria (e.g., similar criteria). For instance, for different criteria (e.g., keywords) associated with content items, the criteria may have different relative pricing indications which indicate one criterion is associated with lower cost content items (e.g., content items having a lower target bid price) than the others.

For each content item identified for analysis, a system may retrieve or extract a target pricing parameter and one or more criteria for the content item. The target pricing parameter may be, for example, a target price related to conversion (e.g., cost per acquisition (CPA) or conversions per cost unit (e.g., conversions per dollar (CPD)). Each content item is classified into one or more categories based on the criteria.

For each category, category pricing parameter data is generated based on a combination of the target pricing parameters of the content items in the category. The category pricing parameter data may include a distribution of target pricing parameters. In some implementations, the category pricing parameter data may include one or more threshold pricing parameters, to classify content items having a higher or lower price value relative to other price values in the category.

For each of the criteria, criteria pricing parameter data is calculated for the criterion based on the target pricing parameters for the content items associated with the criterion. For instance, for a target keyword, a keyword price is calculated based on target pricing parameters (e.g., CPA/CPD) of the content items that include the keyword as a target keyword. The criteria pricing parameter data is correlated by the system to the category pricing parameters.

For each criteria, relative pricing indication data is generated for the criterion based on the correlation of the criteria pricing parameter data to the category pricing parameter data for the one or more categories. The relative pricing indication may be a combined pricing indication for the criterion across all categories to which the criterion is associated, or may be category-specific.

For situations in which the systems discussed herein collect and/or utilize personal information about users, or may make use of personal information, the users may be provided with an opportunity to control whether programs or features that may collect personal information (e.g., information about a user's social network, social actions or activities, a user's preferences, a user's current location, etc.), or to control whether and/or how to receive content from the content server that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server. Further, the individual user information itself is not surfaced to the content provider, so the content provider cannot discern the interactions associated with particular users.

For situations in which the systems discussed herein collect and/or utilize information pertaining to one or more particular content providers, steps may be taken to prevent individualized data for particular content providers from being discoverable or reverse-engineered. In some implementations, the information may be anonymized in one or more ways before it is utilized, such that the identity of the content provider with which it is associated cannot be discerned from the anonymized information. Additionally, data from multiple content providers may be aggregated, and data presented to a content provider may be based on the aggregated data, rather than on individualized data. In some implementations, the system may include one or more filtering conditions to ensure that the aggregated data includes enough data samples from enough content providers to prevent against any individualized content provider data being obtained from the aggregated data. The system does not present individualized data for a content provider to any other content provider.

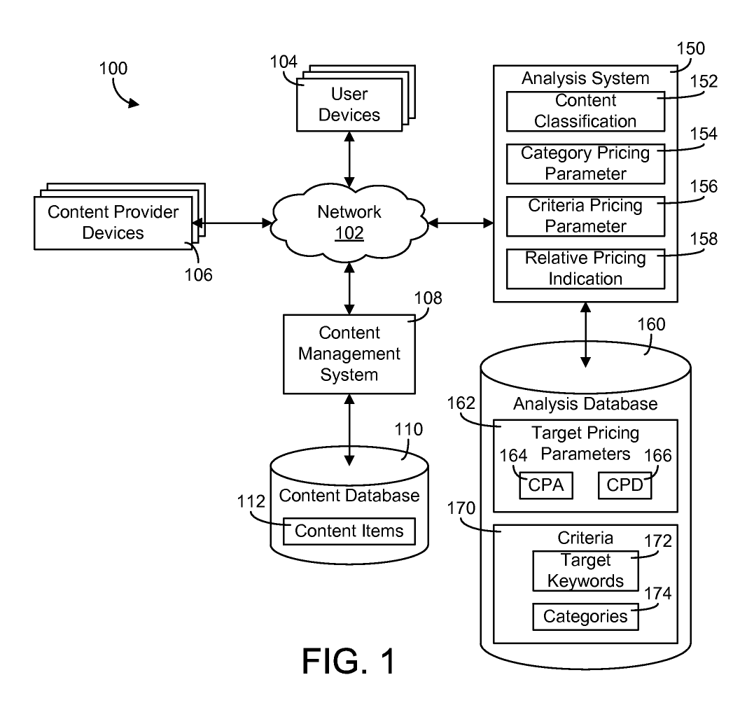

Referring now to FIG. 1, and in brief overview, a block diagram of an analysis system 150 and associated environment 100 is shown according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an Internet browser), media files, and/or any other types of content. A content management system 108 may be configured to select content for display to users within resources (e.g., webpages, applications, etc.) and to provide content items 112 from a content database 110 to user devices 104 over network 102 for display within the resources. The content from which content management system 108 selects items may be provided by one or more content providers via network 102 using one or more content provider devices 106.

In some implementations, bids for content to be selected by content management system 108 may be provided to content management system 108 from content providers participating in an auction using devices, such as content provider devices 106, configured to communicate with content management system 108 through network 102. In such implementations, content management system 108 may determine content to be published in one or more content interfaces of resources (e.g., webpages, applications, etc.) shown on user devices 104 based at least in part on the bids.

An analysis system 150 may be configured to analyze price value characteristics for the content items to determine relative pricing indications. In some implementations, analysis system 150 may receive target pricing parameters 162 for the content items. Target pricing parameters may include, but are not limited to, a cost-per-acquisition (CPA) 164 or a conversions-per-dollar (CPD) 166 parameter. Analysis system 150 may further receive one or more criteria 170 associated with the content items. Criteria may include one or more keywords 172 or categories 174 associated with a content item. Analysis system 150 uses target pricing parameters 172 and criteria 170 to determine a relative pricing indication for each of the criteria. In some embodiments, the relative pricing indication may be used to determine whether to select a particular content item for display or to participate in an auction for providing the content item for display. In some embodiments, the relative pricing indication may be used to select or alter a bid for a content item in an auction.

Referring still to FIG. 1, and in greater detail, user devices 104 and/or content provider devices 106 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 and/or content provider devices 106 may be designed to use various types of software and/or operating systems. In various illustrative implementations, user devices 104 and/or content provider devices 106 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 and/or content provider devices 106 may be configured to receive data from various sources using a network 102. In some implementations, network 102 may include a computing network (e.g., LAN, WAN, Internet, etc.) to which user devices 104 and/or content provider device 106 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

Content management system 108 may be configured to conduct a content auction among third-party content providers to determine which third-party content is to be provided to a user device 104. For example, content management system 108 may conduct a real-time content auction in response to a user device 104 requesting first-party content from a content source (e.g., a website, search engine provider, etc.) or executing a first-party application. Content management system 108 may use any number of factors to determine the winner of the auction. For example, the winner of a content auction may be based in part on the third-party content provider's bid and/or a quality score for the third-party provider's content (e.g., a measure of how likely the user of the user device 104 is to click on the content). In other words, the highest bidder is not necessarily the winner of a content auction conducted by content management system 108, in some implementations.

Content management system 108 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 104. In some implementations, the bid amount may be on a cost per impression or cost per thousand impressions (CPM) basis. In further implementations, a bid amount may correspond to a specified action being performed in response to the third-party content being presented at a user device 104. For example, a bid amount may be a monetary amount that the third-party content provider is willing to pay, should their content be clicked on at the client device, thereby redirecting the client device to the provider's webpage or another resource associated with the content provider. In other words, a bid amount may be a cost per click (CPC) bid amount. In another example, the bid amount may correspond to an action being performed on the third-party provider's website, such as the user of the user device 104 making a purchase. Such bids are typically referred to as being on a cost per acquisition (CPA) or cost per conversion basis.

A campaign created via content management system 108 may also include selection parameters that control when a bid is placed on behalf of a third-party content provider in a content auction. If the third-party content is to be presented in conjunction with search results from a search engine, for example, the selection parameters may include one or more sets of search keywords. For instance, the third-party content provider may only participate in content auctions in which a search query for “golf resorts in California” is sent to a search engine. Other illustrative parameters that control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of an particular online newspaper.

Content management system 108 may also be configured to suggest a bid amount to a third-party content provider when a campaign is created or modified. In some implementations, the suggested bid amount may be based on aggregate bid amounts from the third-party content provider's peers (e.g., other third-party content providers that use the same or similar selection parameters as part of their campaigns). For example, a third-party content provider that wishes to place an advertisement on the sports page of an online newspaper may be shown an average bid amount used by other advertisers on the same page. The suggested bid amount may facilitate the creation of bid amounts across different types of client devices, in some cases. In some implementations, the suggested bid amount may be sent to a third-party content provider as a suggested bid adjustment value. Such an adjustment value may be a suggested modification to an existing bid amount for one type of device, to enter a bid amount for another type of device as part of the same campaign. For example, content management system 108 may suggest that a third-party content provider increase or decrease their bid amount for desktop devices by a certain percentage, to create a bid amount for mobile devices.

Analysis system 150 may be configured to analyze data from analysis database 160 and from various other sources via network 102 to determine relative pricing indication data for criteria, such as keywords, relating to one or more content items. Analysis system 150 may include one or more processors (e.g., any general purpose or special purpose processor), and may include and/or be operably coupled to one or more memories (e.g., any computer-readable storage media, such as a magnetic storage, optical storage, flash storage, RAM, etc.). In various implementations, analysis system 150 and content management system 108 may be implemented as separate systems or integrated within a single system (e.g., content management system 108 may be configured to incorporate some or all of the functions/capabilities of analysis system 150).

Analysis system 150 may include one or more modules (e.g., implemented as computer-readable instructions executable by a processor) configured to perform various functions of analysis system 150. The modules of analysis system 150 may be executed upon, for instance, retrieving content item data relating to a plurality of content items from content database 110 or another source. Upon receiving the content item data, target pricing parameters 162 and one or more criteria 170 associated with the content items are extracted from the content item data (e.g., extracted from data in stored in analysis database 160 and/or retrieved from another source via network 102). Target pricing parameters may include, for instance, a target price related to conversion, such as a cost per acquisition or conversion (CPA) 164 or a conversions per cost unit, such as conversions per dollar (CPD) 166. Criteria may include, for instance, target keywords 172 and/or categories 174 associated with the target keywords. Analysis system 150 may analyze the extracted data to determine relative pricing indication data relating to the content items.

Analysis system 150 may include a content classification module 152 configured to classify each content item within one or more categories, based on criteria 170. For instance, module 152 may classify each content item within one or more categories based on categories related to target keywords associated with the content item, and/or may classify the content item within one or more categories based on categories expressly provided within the criteria. In some implementations, content classification module 152 may determine categories associated with keywords based on a table or other type of data structure associating keywords with one or more categories (e.g., based on subject matter associated with the keywords). In some implementations, content classification module 152 may determine the categories using a suggestion engine configured to generate category/term suggestions based on the keywords. In one such implementation, the suggestion engine may be part of a search engine configured to suggest search results based on input queries.

Analysis system 150 may include a category pricing parameter module 154 configured to generate category pricing parameter data for each category. Module 154 may generate category pricing parameter data for each category to which a content item was classified by module 152. The category pricing parameter data for a category is generated based on a combination of the target pricing parameters for content items within the category. For instance, the combination of the target pricing parameters may be a distribution of the parameters, an average or median of all target pricing parameters of content items within the category, or any other value mathematically derived based on the target pricing parameters.

In some implementations, based on the distribution of target pricing parameters within the category, module 154 may determine one or more threshold pricing parameters. For instance, module 154 may determine a high threshold and low threshold for a category. Content items having target pricing parameters falling above the high threshold are classified as having a high price value relative to other content items, content items having target pricing parameters between the high threshold and low threshold are classified as having an average price value, and content items having target pricing parameters below the low threshold are classified as having a low price value. In other implementations, any number of thresholds may be used for a category, and the threshold values may be determined based on various factors (e.g., specific price values, a percentile ranking of the content items, etc.).

Analysis system 150 may include a criteria pricing parameter module 156 configured to calculate criteria pricing parameter data for each extracted criteria. The criteria pricing parameter data is calculated based on a combination of the target pricing parameters for the content items with which the criterion is associated. In one implementation, for each target keyword extracted by analysis system 150, module 156 may calculate a keyword price based on the target pricing parameters (e.g., CPA or CPD) of the content items that include the keyword within the set of target keywords for the content item.

Analysis system 150 may include a relative pricing indication module 158 configured to generate a relative pricing indication for each extracted criteria. The relative pricing indication data may be generated based on the correlation of the criteria pricing parameter data to the category pricing parameter data. In some implementations, the relative pricing indication data may include a combined pricing indication for the criteria across the categories. For instance, the relative pricing indication data may include an average position of the criteria pricing parameter with respect to the category pricing parameters of the categories to which the criteria relate. In some implementations, module 158 may compare the criteria pricing parameter for a criterion to the category pricing parameter for each of the categories to determine a relative pricing indication for each category. For instance, a particular keyword may be associated with a low price value in a first category (e.g., automotive) but be associated with a medium price value in a second category (e.g., consumer electronics).

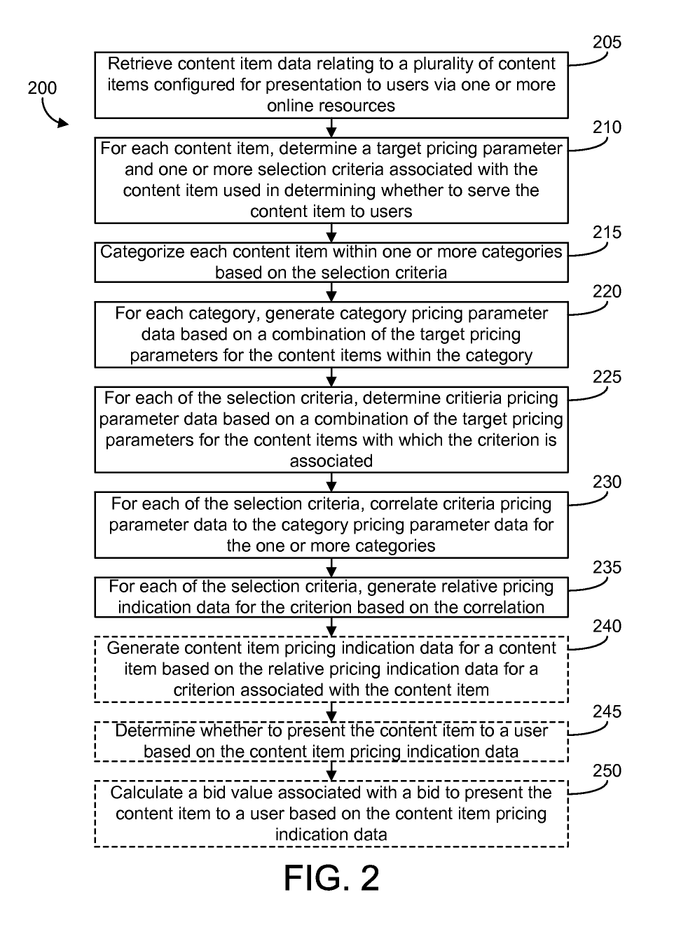

FIG. 2 illustrates a flow diagram of a process 200 for estimating relative pricing indications of content items according to an illustrative implementation. Process 200 may be executed by, for instance, analysis system 150 and may be configured to generate the relative pricing indications for use by content management system 108 or another component of system 100. For instance, the relative pricing indications may be used to select content to provide to user devices 104.

Referring to both FIGS. 1 and 2, analysis system 150 may be configured to retrieve content item data relating to a plurality of content items configured for presentation to users via one or more online resources (block 205). The content item data may be retrieved from, for instance, content database 110 or another source via network 102. The content items for which content item data is retrieved by analysis system 150 may be identified for analysis for a plurality of reasons. For instance, the content items may be for similar products, services, or brands; the content items may be displayed on the same resource; the content items may be selected for analysis by content management system 108; or there may not be a correlation between the content items. Content items may generally include paid and/or unpaid content items (e.g., items displayed as a result of paid bids, items displayed in response to a search query that did not result from paid bids, etc.), and may promote one or more related particular products or services, a content provider, an affiliate of the content provider, a resource (e.g., a website), or otherwise. In one implementation, content items may be selected for analysis by analysis system 150 to help quantify a price level associated with the content items (e.g., on a large scale).

For each of the plurality of content items, analysis system 150 may be configured to determine, from the content item data, a target pricing parameter associated with the content item (block 210). In some implementations, target pricing parameters 162 are retrieved from analysis database 160, or may be received from another source via network 102. A target pricing parameter may be a target price related to conversion. In some implementations, the target pricing parameter may be a cost per acquisition (CPA) 164 or cost per conversion (CPC), or another such metric that measures a cost or price associated with a particular type of interaction between a user and a content item (e.g., an impression, a click, or another desired interaction with the content item). In some implementations, the target pricing parameter may be a conversion per dollar (CPD) 166, or another such metric that measures conversions per cost unit. In some implementations, the target pricing parameters may generally be conversion-related parameters that relate more directly to the value of the goods, services, or brands to which the content items are directed than other types of pricing parameters. In some implementations, the target pricing parameters may additionally or alternatively be directed to parameters not directly related to conversions.

For each of the plurality of content items, analysis system 150 may be configured to determine, from the content item data, one or more selection criteria associated with the content item used in determining whether to serve the content item to users (block 210). In some implementations, criteria 170 are retrieved from analysis database 160, or may be received from another source via network 102.

Criteria may include one or more target keywords 172 or one or more categories 174 associated with the target keywords. In some implementations, the categories may be expressly provided within the criteria (i.e., the categories of a content item may be provided with the content item data at block 205). In other implementations, categories may be retrieved from analysis database 160 based on the content item data retrieved at block 205 (i.e., by selecting categories related to selected target keywords). Target keywords are keywords associated with a particular content item. For instance, a content item may be selected for display on a resource in response to a user search query including the target keyword.

For each of the plurality of content items, the content item may be categorized within one or more categories based on the criteria (block 215) by content classification module 152. In some implementations, analysis system 150 may categorize each content item within a category based on the target keywords associated with the content item. In other implementations, analysis system 150 may simply base the categorization on the categories expressly provided within the criteria received at block 210. In some implementations, a content item may be categorized within more than one category.

For each of the categories, category pricing parameter data may be generated for the category (block 220) by category pricing parameter module 154. The category pricing parameter data may be generated based on a combination of the target pricing parameters for the content items within the category. The category pricing parameter data for each category provides an indication of a level for the target pricing parameters of the content items within the category. In some implementations, the category pricing parameter data may include a distribution of target pricing parameters for a category. For instance, analysis system 150 may calculate a distribution of CPA values or CPD values for each content item classified within the category. The distribution of values may be representative of a range of conversion-related values. In some implementations, an average target pricing parameter or median target pricing parameter (e.g., an average CPA or CPD) may be calculated. The category pricing parameter data may be representative of or related to pricing information related to the content items in each category.

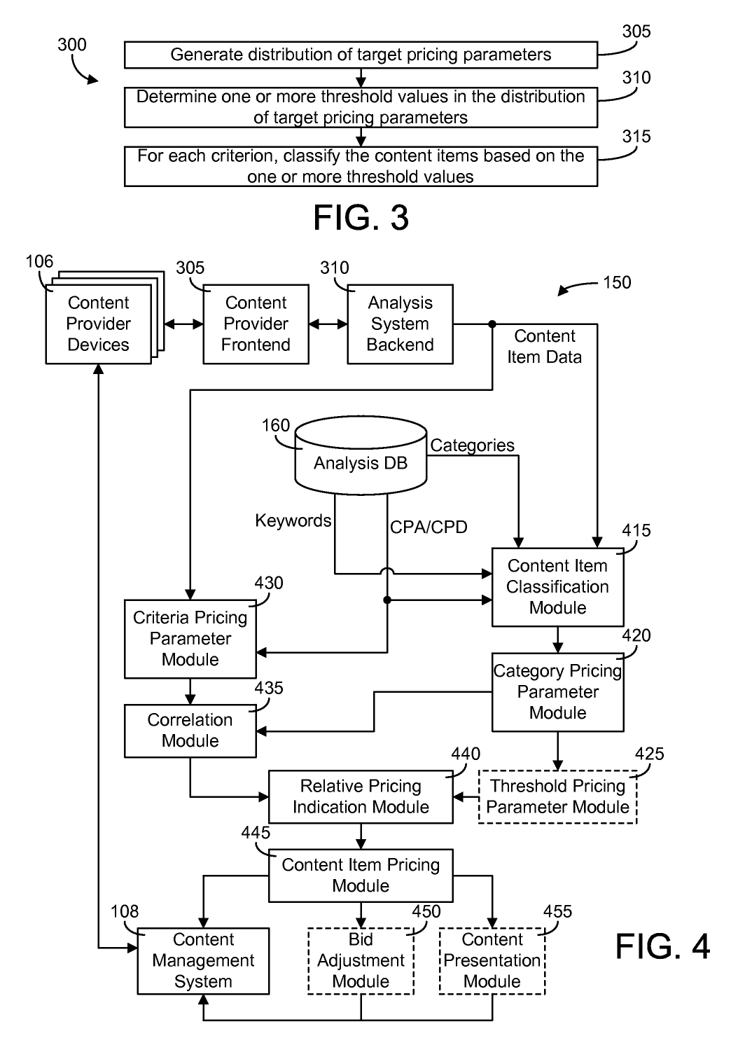

In some implementations, category pricing parameter data may include a threshold pricing parameter that defines if a particular content item within the category has a high or low price value within the category. The process of determining threshold pricing parameter data, according to one illustrative implementation, is described in greater detail in FIG. 3.

For each of the selection criteria, criteria pricing parameter data may be calculated based on a combination of the target pricing parameters for the content items with which the criterion is associated (block 225) by criteria pricing parameter module 156. The criteria pricing parameter data for each criterion providing an indication of a level for the target pricing parameters of the content items associated with the criterion. For instance, in some implementations, for each target keyword identified at block 210, analysis system 150 may calculate a keyword price based on the target pricing parameters (e.g., CPA or CPD) of the content items that include the keyword within the set of target keywords for the content item. The criteria pricing parameter may be an average or mean of the target pricing parameters, a maximum or minimum, or any other value calculable from the target pricing parameters. The criteria pricing parameter may be representative of or related to a price associated with the content items associated with the criteria.

The criteria pricing parameter data determined at block 225 is correlated to the category pricing parameter data for the one or more categories (block 230). For each criterion and category, the criterion and associated criteria pricing parameter data is correlated to the category and associated category pricing parameter data. In other words, the correlation is an indication of how the criteria pricing parameter data for a criterion compares with category pricing parameter data for all criterion associated with the category.

For each of the criteria, relative pricing indication data is generated for the criterion based on the correlation (block 235) by relative pricing indication module 158. The relative pricing indication data for each criterion provides an indication of a relative price level associated with the criterion in relation to the other criteria represented within the one or more categories. In some implementations, the relative pricing indication data for a criterion may include a combined pricing indication across the categories with which the criterion is associated. For instance, the combined pricing indication may be an average position of the criteria pricing parameter with respect to the category pricing parameters of the category (i.e., how the criterion ranks compared to other criterion associated with the category). In some implementations, system 150 may generate the combined pricing indication for a criterion by determining a position of the criteria pricing parameter for the criterion within a range of category pricing parameters across the categories. In some implementations, the category pricing parameter(s) may be a single value (e.g., an average value), and system 150 may generate the combined pricing indication based on a difference or ratio between the category pricing parameter(s) (e.g., an average value across the categories) and the criteria pricing parameter for the criterion. In one such implementation, the combined pricing indication may be, or be based on, a ratio between the criteria and category parameters. In another implementation, the combined pricing indication may be, or be based on, a difference between the criteria and category parameters. For instance, the combined pricing indication may indicate a high value if the criteria pricing parameter exceeds the category pricing parameter by at least a threshold amount, a low value if the criteria pricing parameters is less than the category pricing parameter by at least the threshold amount, and an average value if the criteria pricing parameter is within the threshold amount of the category pricing parameter.

In some implementations, the relative pricing indication may be category-specific. For instance, analysis system 150 may compare the criteria pricing parameter for a criterion to the category pricing parameter for each category to determine the relative pricing indication for each category. In one such illustrative implementation, a particular keyword may be associated with a low price value in a first category (i.e., the criteria pricing parameter for the keyword falls below a low threshold for the first category as determined in process 300), but with a high price value in a second category (i.e., the criteria pricing parameter for the keywords falls above a high threshold for the second category as determined in process 300).

Process 200 may optionally include generating content item pricing indication data for a content item based on the relative pricing indication data (block 240). For instance, the relative pricing indication for a keyword (or other criterion) associated with the content item may be used to generate the content item pricing indication data. The content item pricing indication data may generally be a value or set of values indicative of the worth of the content item in one or more categories. In some implementations, the content item pricing indication data may be a distribution of relative pricing indications for the target keywords of the content item. In some implementations, the content item pricing indication data may be an average, median, maximum, minimum, etc. of the relative pricing indications for the target keywords. In some implementations, system 150 may generate a separate content item pricing indication for each of multiple categories. For instance, system 150 may generate the content item pricing indication for a first category based on relative pricing indication data for the target keywords of the item corresponding to the first category, and may generate the content item pricing indication for a second category based on relative pricing indication data for the target keywords corresponding to a second category.

In some implementations, process 200 may include determining whether to present the content item to a user (block 245) or calculating a bid value associated with a bid to present the content item to a user based on the content item pricing indication data (block 250). In some implementations, blocks 245 and/or 250 may be executed by system 150, and commands may be sent by system 150 to other components (e.g., content management system 108) to cause the other components to take certain actions, such as selecting or not selecting certain content items for inclusion in auctions and/or modifying bid values for one or more items. In some implementations, blocks 245 and/or 250 may be executed by, for instance, content management system 108, or another component of system 100. The relative pricing indication data and content item pricing indication data generated by process 200 may be used by content management system 108 to help select which content items to display on a resource, as described above with reference to FIG. 1. In other words, the relative pricing indication data and content item pricing indication data are used to better refine content selection in system 100. In some implementations, one or more bids may be modified based on the data. For instance, a content provider may specify that a bid multiplier increasing a bid should be applied for content items having a high pricing indication, and a bid multiplier decreasing a bid should be applied for content items having a low pricing indication.

Referring now to FIG. 3, a flow diagram of a process 300 for determining a threshold pricing parameter for the category pricing parameter data is shown according to an illustrative implementation. Process 300 may be executed as part of the activities of block 220 of process 200, for instance.

For each category, category pricing parameter data may be generated based on a combination of the target pricing parameters for the content items within the category. More particularly, the category pricing parameter data generated may include a distribution of target pricing parameters (block 305). For instance, the distribution of target pricing parameters may include a distribution of CPA values or CPD values for each content item classified within the category. The distribution of values are representative of a range of conversion-related values.

One or more threshold values may be determined for the distribution of target pricing parameters (block 310). In one illustrative implementation, a high threshold value and low threshold value may be determined for the distribution. In other implementations, a single threshold value may be determined, or more than two threshold values may be determined.

In some implementations, the distribution of values may be analyzed to determine where to set one or more threshold values. In one such implementation, the threshold values may be set based on a percentile ranking of the values. For instance, values in the 40^{th} to 60^{th} percentile may be set as an average value, and values above or below the percentiles are classified as high values and low values, respectively. In another implementation, the distribution of values may be analyzed for clusters of similar values, and the thresholds may be set at or near break points in between the clusters. For instance, if a distribution includes ten CPA values of $5.48, $5.45, $5.60, $3.23, $3.21, $3.15, $1.20, $1.25, $1.33, and $1.30, the thresholds may be set at or near $5 and $3. In another implementation, a threshold value may be set as a chosen value (i.e., all values above a specific value, either calculated by analysis system 150 or pre-selected), and all values above the threshold value are classified as high values.

Each criterion may be classified based on the one or more threshold values (block 315). For instance, if a high threshold value and low threshold value are determined at block 310, each criterion may be placed in one of three price value ranges. Criteria having criteria pricing parameters falling above the high threshold may be classified as having a high price value relative to the category. Criteria having criteria pricing parameters falling between the low threshold and high threshold may be classified as having an average price value. Criteria having criteria pricing parameters falling below the low threshold may be classified as having a low price value. In other implementations, there may be more or fewer price value ranges depending on the number of thresholds determined. For instance, in one implementation, each criterion having a criteria pricing parameter above a given value may be classified as having a high price value, each criterion falling within a top percentile of criteria by parameter value may be classified as having a high price value, each criterion falling within the 45^{th} and 60^{th} percentile may be classified as having an average price value, and so forth. In some implementations, a similar process may be used to classify content item pricing parameters for particular categories.

Referring now to FIG. 4, one detailed illustrative implementation of analysis system 150 is provided. In the illustrated implementation, analysis system 150 includes a content provider frontend 405, an analysis system backend 410, and a plurality of modules 415-455 to execute the systems and methods as described in FIGS. 1-2. It should be understood that the detailed implementation of analysis system 150 shown in FIG. 4 is provided for purposes of illustration, and in other implementations, analysis system 150 may include additional, fewer, and/or different components. Further, each of the illustrated systems and/or components may be implemented as a separate computing system, multiple systems may be combined within a single hardware system, and/or one or more systems or components may be implemented in a cloud, or distributed computing, environment.

Content provider devices 106 may provide information to and/or receive information from analysis system 150 via a content provider frontend 405. Content provider frontend 405 may provide an interface through which content providers can provide data, modify settings or parameters used by analysis system 150, receive information from analysis system 150, etc. In some implementations, content provider frontend 405 may be or include a web-based user interface (e.g., implemented via a web-based programming language such as HTML, Javascript®, etc.). In some implementations, content provider frontend 405 may include a custom API specific to a particular content provider. In some implementations, content provider frontend 405 may allow content providers to upload data sets individually and/or in batches. While the implementation shown in FIG. 4 illustrates content provider devices 106 and frontend 405, other components of system 100 may connect with analysis system 150 in a similar manner.

Content provider frontend 405 may transmit data to and receive data from an analysis system backend 410. Analysis system backend 410 may be configured to retrieve data and/or generate commands needed to perform various functions of analysis system 150. In some implementations, analysis system backend 410 may implement the various functions by transmitting commands to various modules configured to carry out particular functions or sets of functions. For instance, analysis system backend 410 may collect data relating to a plurality of content items received from content provider devices 106, content management system 108, or another source. Analysis system backend 410 may transmit the content item data to content item classification module 415 and criteria pricing parameter module 430. The content item data may be any type of data related to content items configured to be presented to users, and may be provided in any type of format. For instance, content item data may be structured as a lookup table, linked lists, in trees, or as any other type of data structure (e.g., records, lists, arrays, queue, stack, etc.). Content item data may include a description of the content item, keywords, the type of content item (e.g., if the content item includes an image, video, text, flash, etc.) or any other information that distinguishes the content item from other content items.

Content item classification module 415 may be configured to classify content items within one or more categories. Content item classification module 415 may be configured to receive content item data relating to a plurality of content items. Content item classification module 415 may use the content item data to extract one or more criteria (such as keywords) for each content item from analysis database 160. Content item classification module 415 further extracts category data from analysis database 160 (or receives category data from another source via analysis system backend 410). Content item classification module 415 may determine to which categories a content item may be classified based on the criteria associated with the content items. Content item classification module 415 then classifies each content item within one or more categories based on the criteria.

Content item classification module 415 may provide data reflecting the categories under which a content item was classified to category pricing parameter module 420. Category pricing parameter module 420 may receive target pricing parameters (such as CPA or CPD) associated with the content items and, for each category, generate category pricing parameter data. The category pricing parameter data may be based on a combination of the target pricing parameters for the content items in each category. The combination may be, for instance, a distribution of target pricing parameters for the content items in each category. The category pricing parameter data may be provided to correlation module 435 and relative pricing indication module 440.

The target pricing parameters (and other data provided by an outside source or analysis database 160) may be provided in any type of format or data structure. For instance, a CPA or CPD associated with a content item may be included within a lookup table included as part of the content item data. In another instance, a CPA or CPD may be extracted from a file in analysis database 160 based on identifiers corresponding to the related content items in the content item data. In another instance, In another instance, a CPA or CPD may be retrieved from a node or subtree of a tree of linked nodes. In another instance, CPA or CPD data may be retrieved from analysis database via a queue or stack. It should be appreciated that the target pricing parameters and other data may be stored in any type of data structure and any type of data retrieval process may be used to access the data.

In some implementations, analysis system 150 may include a threshold pricing parameter module 425 configured to calculate a threshold pricing parameter based on the distribution of target pricing parameters. For instance, threshold pricing parameter module 425 may determine a high threshold and low threshold for the target pricing parameters, and may classify each content item as having a high price value, medium price value, or low price value. In other implementations, any number of thresholds and price values may be set by threshold pricing parameter module 425. The classification of the content items in the category may be provided to relative pricing indication module 440.

Criteria pricing parameter module 430 may be configured to calculate criteria pricing parameter data for each criteria (e.g., keyword). Criteria pricing parameter module 430 may calculate the criteria pricing parameter data based on a combination of the target pricing parameters for the content items with which the criterion is associated. The combination may be, for instance, an average of the target pricing parameter for each content item associated with the criteria. Criteria pricing parameter module 430 may receive content item data for the content items from analysis system backend 410, and target pricing parameters (e.g., CPA/CPD) and criteria (e.g., keywords) from analysis database 160.

Correlation module 435 may be configured to receive the criteria pricing parameter data from criteria pricing parameter module 430 and category pricing parameter data from category pricing parameter module 420. Correlation module 435 may be configured to correlate the two pairs of data. The correlation may generally be an indication of how the criteria pricing parameter data for a criterion compares with category pricing parameter data for all criterion associated with the category. The correlation may be provided to relative pricing indication module 440.

Relative pricing module 440 may be configured to receive category pricing parameter data (which may or may not include threshold pricing parameter data) and a correlation between the category pricing parameter data and criteria pricing parameter data. Relative pricing module 440 may be configured to generate relative pricing indication data for each criteria based on the correlation of the data. For instance, the relative pricing indication data may be a combined pricing indication for each criteria across all categories (e.g., an average position of the criteria pricing parameter with respect to the category pricing parameters of the categories).

In some implementations, the relative pricing indication may be category-specific instead of general towards all categories. For instance, in some implementations, the criteria pricing parameter for a criterion may be compared to the category pricing parameter for each category to determine a relative pricing indication for each category (e.g., a particular keyword may be associated with a low price value in one category and a high price value in another category.

In one implementation, analysis system 150 may be configured to rank each criteria based on the relative pricing indication data. For instance, for each category, all criteria associated with the category may be ranked within the category based on its relative pricing indication compared to the distribution of relative pricing indications in the category.

Analysis system 150 may further include a content item pricing module 445 configured to generate content item pricing indication data for a content item based on the relative pricing indication data for a criterion of the content item. Based on the content item pricing indication data, analysis system 150 may include various modules to determine whether the content item is to be presented to a user via a resource. For instance, analysis system 150 may include a bid adjustment module 450 configured to adjust a bid associated with the content item, which may impact whether the content item is ultimately selected for display on a resource. Bid adjustment module 450 may be configured to, for example, apply a multiplier to a bid amount associated with a content item, the multiplier relating to the content item pricing indication data.

As another example, analysis system 150 may include a content presentation module 455 configured to determine whether or not to display the content item on a resource based on the content item pricing indication data. Modules 450, 455 may provide an indication to content management system 108 regarding if a content item should be presented to a user via a resource based on the content item pricing indication data, or an indication that may be used by system 108 in determining whether to include the content item within an auction. In some such implementations, the indication may be considered as a factor in a quality score associated with the content item, or a separate factor applied in determining whether to include the content item within an auction. In another implementation, the activities of modules 450, 455 may be handled by content management system 108.

Referring generally to FIGS. 1-4, in various implementations, categories may be hierarchical. One category may be a subset of another category; for instance, the category “organic grocery store” may be a subset of the category “grocery store”. In such an implementation, for a content that is determined to belong to both categories, category pricing parameter data may be generated for both categories to which the keywords for the content item belongs. For each keyword associated with the content item, relative pricing indication data may be generated. This may result in different (or the same) relative pricing indication data for the two categories.

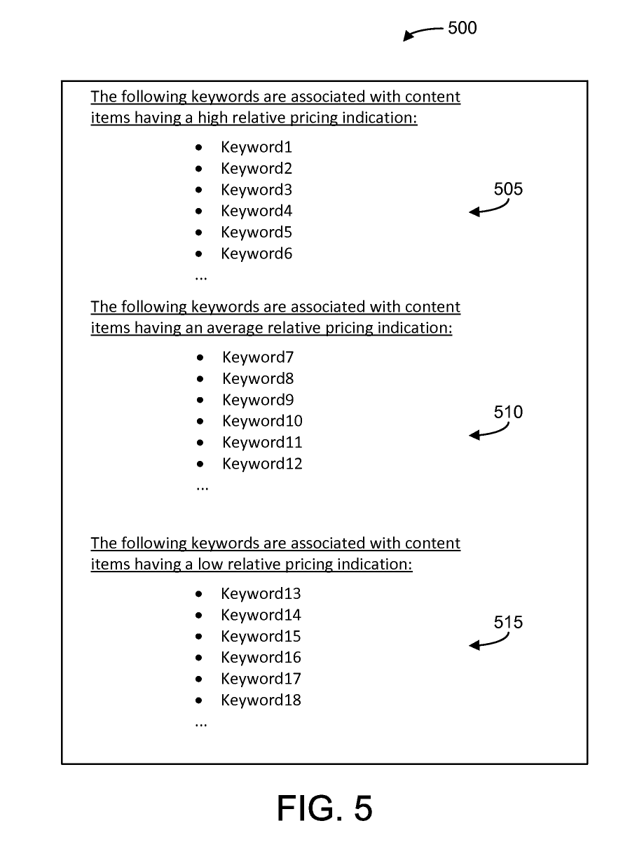

Referring now to FIG. 5, an illustration of a user interface 500 configured to provide information pertaining to relative pricing indication data for a set of criteria for content items is shown according to an illustrative implementation. User interface 500 may be presented to, for instance, an application of content provider device 106 or user device 104. User interface 500 may be presented to illustrate relative pricing indication data for a set of criteria as determined by analysis system 150. In various implementations, a user may request the relative pricing indication or the relative pricing indication data may be automatically provided to the user (i.e., the relative pricing indication data may be provided to a content provider to allow the content provider to analyze performance of content items of the content provider).

User interface 500 is shown to include a first portion 505 in which keywords determined to have a high price value or level are listed. For instance, referring also to FIG. 3, a high threshold value and low threshold value may be determined for content items and criteria classified within a category. Keywords determined to have fallen above the high threshold value may be listed in portion 505. User interface further includes a second portion 510 for keywords which are determined to have an average price value or level, and a third portion 515 for keywords which are determined to have a low price value or level.

In various implementations, user interface 500 may further include other information related to the keywords or other criteria. For instance, user interface 500 may include more sections further breaking down the keywords into different price values or levels; user interface 500 may include one or more sections for indicating the actual threshold values; user interface 500 may include, for each keyword, a price value, and the like. In some implementations, a user may select one or more keywords to access more information relating to the price value of the keyword, the user may sort keywords on user interface 500 (i.e., based on the price value of each keyword), and the like.

In various implementations, the keywords listed in user interface 500 may be related or unrelated. For instance, the user may choose to generate a report for a group of like keywords, the user may choose to generate a report for all keywords related to a product or service the user is associated with, and the like. As shown in user interface 500, an unrelated group of keywords are shown.

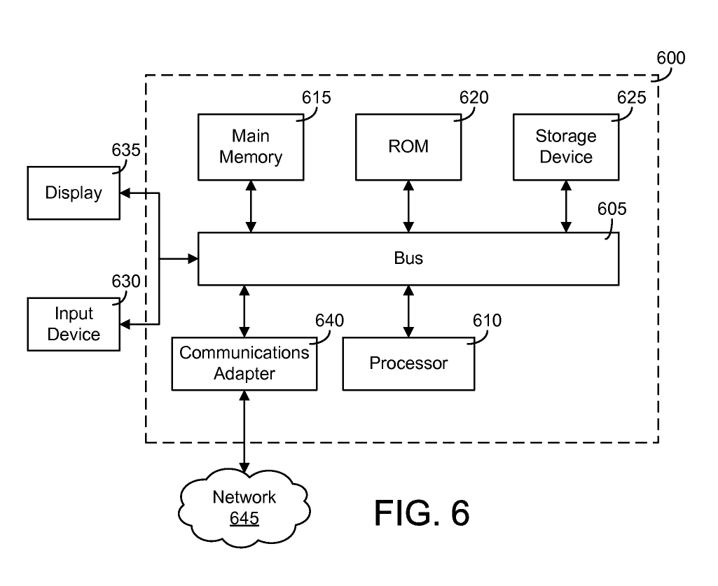

FIG. 6 illustrates a depiction of a computer system 600 that can be used, for example, to implement an illustrative user device 104, an illustrative content management system 108, an illustrative content provider device 106, an illustrative analysis system 150, and/or various other illustrative systems described in the present disclosure. Computing system 600 includes a bus 605 or other communication component for communicating information and a processor 610 coupled to bus 605 for processing information. Computing system 600 also includes main memory 615, such as a random access memory (RAM) or other dynamic storage device, coupled to bus 605 for storing information, and instructions to be executed by processor 610. Main memory 615 can also be used for storing position information, temporary variables, or other intermediate information during execution of instructions by processor 610. Computing system 600 may further include a read only memory (ROM) 610 or other static storage device coupled to bus 605 for storing static information and instructions for processor 610. A storage device 625, such as a solid state device, magnetic disk or optical disk, is coupled to bus 605 for persistently storing information and instructions.

Computing system 600 may be coupled via bus 605 to a display 635, such as a liquid crystal display, or active matrix display, for displaying information to a user. An input device 630, such as a keyboard including alphanumeric and other keys, may be coupled to bus 605 for communicating information, and command selections to processor 610. In another implementation, input device 630 has a touch screen display 635. Input device 630 can include a cursor control, such as a mouse, a trackball, or cursor direction keys, for communicating direction information and command selections to processor 610 and for controlling cursor movement on display 635.

In some implementations, computing system 600 may include a communications adapter 640, such as a networking adapter. Communications adapter 640 may be coupled to bus 605 and may be configured to enable communications with a computing or communications network 645 and/or other computing systems. In various illustrative implementations, any type of networking configuration may be achieved using communications adapter 640, such as wired (e.g., via Ethernet®), wireless (e.g., via WiFi®, Bluetooth®, etc.), pre-configured, ad-hoc, LAN, WAN, etc.

According to various implementations, the processes that effectuate illustrative implementations that are described herein can be achieved by computing system 600 in response to processor 610 executing an arrangement of instructions contained in main memory 615. Such instructions can be read into main memory 615 from another computer-readable medium, such as storage device 625. Execution of the arrangement of instructions contained in main memory 615 causes computing system 600 to perform the illustrative processes described herein. One or more processors in a multi-processing arrangement may also be employed to execute the instructions contained in main memory 615. In alternative implementations, hard-wired circuitry may be used in place of or in combination with software instructions to implement illustrative implementations. Thus, implementations are not limited to any specific combination of hardware circuitry and software.

Although an example processing system has been described in FIG. 6, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method comprising:
retrieving, by one or more processors, content item data relating to a plurality of content items configured for presentation to users via one or more online resources;
for each of the plurality of content items:
determining from the content item data, by the one or more processors, a target pricing parameter associated with the content item;
determining from the content item data, by the one or more processors, one or more selection criteria associated with the content item used in determining whether to serve the content item to the users; and
categorizing, by the one or more processors, the content item within multiple, different categories based on the selection criteria;
for each category of the multiple, different categories, generating, by the one or more processors, category pricing parameter data based on a combination of the target pricing parameters for a set of the content items within the category, the category pricing parameter data for each category providing an indication of a level for the target pricing parameters of the content items within the category; and
for each of the selection criteria, determining, by the one or more processors, criteria pricing parameter data based on a combination of the target pricing parameters for a set of content items with which the selection criterion is associated, the criteria pricing parameter data for each selection criterion providing an indication of a level for the target pricing parameters of the content items associated with the criterion;
for each category of the multiple, different categories and each selection criterion of the selection criteria, correlating, by the one or more processors, the criteria pricing parameter data to the category pricing parameter data, the correlating including:
identifying a plurality of categories of the multiple, different categories that each include the selection criteria;
determining, for each identified category, a position of the criteria pricing parameter data for the selection criteria with respect to the category pricing parameter data of the identified category; and
determining, based on each position of the criteria pricing parameter data with respect to the category pricing parameter data for each of the identified categories, an average positioning of the criteria pricing parameter data for the selection criteria with respect to the category pricing parameter data of the identified categories; and
for each selection criterion of the selection criteria, generating, by the one or more processors, for each category, relative pricing indication data for the selection criterion based on the average positioning of the criteria pricing parameter data to the category pricing parameter data for the category, the relative pricing indication data for each selection criterion providing an indication of a relative price level associated with the selection criterion in relation to the other selection criteria represented within the category;
for a particular selection criterion of the selection criteria of a particular content item of the plurality of content items:
determining that the relative pricing indication data is less than a first threshold associated with a first category of the multiple, different categories, and based on the determination, generating first content item pricing indication data indicating a first value of the particular content item associated with the first category with respect to other content items associated with the first category;
determining that the relative pricing indication data is greater than a second threshold associated with a second category of the multiple, different categories, and based on the determination, generating second content item pricing indication data indicating a second value of the particular content item associated with the second category with respect to other content items associated with the second category; and
updating i) a first portion of a graphical user interface to indicate the first value of the particular content item and ii) a second portion of the graphical user interface to indicate the second value of the particular content item, the first portion of the graphical user interface associated with the first category and the second portion of the graphical user interface associated with the second category.

2. The method of claim 1, wherein the target pricing parameter comprises a cost per acquisition or a conversions per cost unit.

3. The method of claim 1, wherein the one or more selection criteria comprise one or more target keywords associated with the content item.

4. The method of claim 1, wherein:
the category pricing parameter data for each of the categories comprises a distribution of the target pricing parameters for the content items within the category;
the method further comprises, for each category of the multiple, different categories, calculating a threshold pricing parameter based on the distribution of the target pricing parameters for the content items within the category; and
generating the relative pricing indication data for each of the selection criteria comprises comparing the criteria pricing parameter data to the distribution of the target pricing parameters for at least one of the categories based on the threshold pricing parameter for the category.

5. The method of claim 1, the generating the relative pricing indication data further comprising, for a first criterion, generating category-specific pricing indication data for each of the multiple, different categories, each of the category-specific pricing indication data generated by correlating the criteria pricing parameter data of the first criterion with the category pricing parameter data of the category.

6. The method of claim 5, wherein:
the category pricing parameter data for each of the categories comprises a distribution of the target pricing parameters for the content items within the category;
the method further comprises, for each category of the multiple, different categories, calculating a threshold pricing parameter based on the distribution of the target pricing parameters for the content items within the category; and
generating each of the category-specific pricing indication data comprises correlating the criteria pricing parameter data of the first criterion to the distribution of target pricing parameters for the category based on the threshold pricing parameter for the category.

7. The method of claim 1, further comprising generating content item pricing indication data for a first content item based on the relative pricing indication data for a first criterion of the one or more selection criteria, the first criterion associated with the first content item.

8. The method of claim 7, further comprising determining whether to present the first content item to a user based on the content item pricing indication data.

9. The method of claim 7, further comprising calculating a bid value associated with a bid to present the first content item to a user based on the content item pricing indication data.

10. A system comprising:
at least one computing device operably coupled to at least one memory and configured to:
retrieve content item data relating to a plurality of content items configured for presentation to users via one or more online resources;
for each of the plurality of content items:
determine from the content item data a target pricing parameter associated with the content item;
determine from the content item data one or more selection criteria associated with the content item used in determining whether to serve the content item to the user; and
categorize the content item within multiple, different categories based on the selection criteria;
for each category of the multiple, different categories, generate category pricing parameter data based on a combination of the target pricing parameters for a set of the content items within the category, the category pricing parameter data for each category providing an indication of a level for the target pricing parameters of the content items within the category; and
for each of the selection criteria, determine criteria pricing parameter data based on a combination of the target pricing parameters for a set of content items with which the selection criterion is associated, the criteria pricing parameter data for each criterion providing an indication of a level for the target pricing parameters of the content items associated with the criterion;
for each category of the multiple, different categories and each selection criterion of the selection criteria, correlate the criteria pricing parameter data to the category pricing parameter data, the correlating including:
identify a plurality of categories of the multiple, different categories that each include the selection criteria;
determine, for each identified category, a position of the criteria pricing parameter data for the selection criteria with respect to the category pricing parameter data of the identified category; and
determine, based on each position of the criteria pricing parameter data with respect to the category pricing parameter data for each of the identified categories, an average positioning of the criteria pricing parameter data for the selection criteria with respect to the category pricing parameter data of the identified categories; and
for each selection criterion of the selection criteria, generate, for each category, relative pricing indication data for the selection criterion based on the average positioning of the criteria pricing parameter data to the category pricing parameter data for the category, the relative pricing indication data for each selection criterion providing an indication of a relative price level associated with the selection criterion in relation to the other criteria represented within the category;
for a particular selection criterion of the selection criteria of a particular content item of the plurality of content items:
determine that the relative pricing indication data is less than a first threshold associated with a first category of the multiple, different categories, and based on the determination, generating first content item pricing indication data indicating a first value of the particular content item associated with the first category with respect to other content items associated with the first category;
determine that the relative pricing indication data is greater than a second threshold associated with a second category of the multiple, different categories, and based on the determination, generating second content item pricing indication data indicating a second value of the particular content item associated with the second category with respect to other content items associated with the second category; and
update i) a first portion of a graphical user interface to indicate the first value of the particular content item and ii) a second portion of the graphical user interface to indicate the second value of the particular content item, the first portion of the graphical user interface associated with the first category and the second portion of the graphical user interface associated with the second category.

11. The system of claim 10, wherein:
the category pricing parameter data for each of the categories comprises a distribution of the target pricing parameters for the content items within the category;
the at least one computing device is further configured to, for each category of the multiple, different categories, calculate a threshold pricing parameter based on the distribution of the target pricing parameters for the content items within the category; and
the at least one computing device is configured to generate the relative pricing indication data for each of the selection criteria by comparing the criteria pricing parameter data to the distribution of the target pricing parameters for at least one of the categories based on the threshold pricing parameter for the category.

12. The system of claim 10, wherein the at least one computing device is configured to generate, for a first criterion, category-specific pricing indication data for each of the multiple, different categories, each of the category-specific pricing indication data generated by correlating the criteria pricing parameter data of the first criterion with the category pricing parameter data of the category.

13. The system of claim 12, wherein:
the category pricing parameter data for each of the categories comprises a distribution of the target pricing parameters for the content items within the category;
the at least one computing device is further configured to, for each category of the multiple, different categories, calculate a threshold pricing parameter based on the distribution of the target pricing parameters for the content items within the category; and
the at least one computing device is configured to generate each of the category-specific pricing indication data by correlating the criteria pricing parameter data of the first criterion to the distribution of target pricing parameters for the category based on the threshold pricing parameter for the category.

14. The system of claim 10, wherein the at least one computing device is further configured to generate content item pricing indication data for a first content item based on the relative pricing indication data for a first criterion of the one or more selection criteria, the first criterion associated with the first content item.

15. The system of claim 14, wherein the at least one computing device is further configured to do at least one of the following:
determine whether to present the first content item to a user based on the content item pricing indication data; or
calculate a bid value associated with a bid to present the first content item to a user based on the content item pricing indication data.

16. One or more non-transitory computer-readable storage media having instructions stored thereon that, when executed by one or more processors, cause the one or more processors to execute operations comprising:
retrieving content item data relating to a plurality of content items configured for presentation to users via one or more online resources;
for each of the plurality of content items:
determining from the content item data a target pricing parameter associated with the content item;
determining from the content item data one or more selection criteria associated with the content item used in determining whether to serve the content item to the users; and
categorizing the content item within multiple, different categories based on the selection criteria;
for each category of the multiple, different categories, generating category pricing parameter data based on a combination of the target pricing parameters for a set of the content items within the category, the category pricing parameter data for each category providing an indication of a level for the target pricing parameters of the content items within the category; and
for each of the selection criteria, determining criteria pricing parameter data based on a combination of the target pricing parameters for a set of content items with which the selection criterion is associated, the criteria pricing parameter data for each selection criterion providing an indication of a level for the target pricing parameters of the content items associated with the criterion;
for each category of the multiple, different categories and each selection criterion of the selection criteria, correlating the criteria pricing parameter data to the category pricing parameter data the correlating including:
identifying a plurality of categories of the multiple, different categories that each include the selection criteria;
determining, for each identified category, a position of the criteria pricing parameter data for the selection criteria with respect to the category pricing parameter data of the identified category; and
determining, based on each position of the criteria pricing parameter data with respect to the category pricing parameter data for each of the identified categories, an average positioning of the criteria pricing parameter data for the selection criteria with respect to the category pricing parameter data of the identified categories; and
for each selection criterion of the selection criteria, generating, for each category, relative pricing indication data for the selection criterion based on the average positioning of the criteria pricing parameter data to the category pricing parameter data for the category, the relative pricing indication data for each selection criterion providing an indication of a relative price level associated with the selection criterion in relation to the other selection criteria represented within the category;
for a particular selection criterion of the selection criteria of a particular content item of the plurality of content items:
determining that the relative pricing indication data is less than a first threshold associated with a first category of the multiple, different categories, and based on the determination, generating first content item pricing indication data indicating a first value of the particular content item associated with the first category with respect to other content items associated with the first category;
determining that the relative pricing indication data is greater than a second threshold associated with a second category of the multiple, different categories, and based on the determination, generating second content item pricing indication data indicating a second value of the particular content item associated with the second category with respect to other content items associated with the second category; and
updating i) a first portion of a graphical user interface to indicate the first value of the particular content item and ii) a second portion of the graphical user interface to indicate the second value of the particular content item, the first portion of the graphical user interface associated with the first category and the second portion of the graphical user interface associated with the second category.

17. The one or more computer-readable storage media of claim 16, wherein:
the category pricing parameter data for each of the categories comprises a distribution of the target pricing parameters for the content items within the category;
the operations further comprise, for each category of the multiple different categories, calculating a threshold pricing parameter based on the distribution of the target pricing parameters for the content items within the category; and
generating the relative pricing indication data for each of the selection criteria comprises comparing the criteria pricing parameter data to the distribution of the target pricing parameters for at least one of the categories based on the threshold pricing parameter for the category.

18. The one or more computer-readable storage media of claim 16, the operation of generating the relative pricing indication data further comprising, for a first criterion, generating category-specific pricing indication data for each of the multiple, different categories, each of the category-specific pricing indication data generated by correlating the criteria pricing parameter data of the first criterion with the category pricing parameter data of the category.

19. The one or more computer-readable storage media of claim 18, wherein:
the category pricing parameter data for each of the categories comprises a distribution of the target pricing parameters for the content items within the category;
the operations further comprise, for each category of the multiple, different categories, calculating a threshold pricing parameter based on the distribution of the target pricing parameters for the content items within the category; and
generating each of the category-specific pricing indication data comprises correlating the criteria pricing parameter data of the first criterion to the distribution of target pricing parameters for the category based on the threshold pricing parameter for the category.

20. The one or more computer-readable storage media of claim 16, the operations further comprising generating content item pricing indication data for a first content item based on the relative pricing indication data for a first criterion of the one or more selection criteria, the first criterion associated with the first content item.
